(19) United States
(12) Patent Application Publication
(10) Pub. No.: US 2016/0021622 A1
(43) Pub. Date: Jan. 21, 2016

(54) OUTPUT POWER CONTROL FOR WIRELESS LOCAL AREA NETWORKS

(71) Applicant: Sony Corporation, Tokyo (JP)

(72) Inventors: Rickard Ljung, Helsingborg (SE); Peter Karlsson, Lund (SE); Kåre Agardh, Rydebäck (SE)

(21) Appl. No.: 14/385,777

(22) PCT Filed: Oct. 11, 2013
(86) PCT No.: PCT/IB2013/002268

§ 371 Date: Sep. 17, 2014

(51) Int. Cl. H04W 52/26; H04W 72/08

(52) U.S. Cl. CPC H04W 52/26; H04W 72/085; H04W 84/12

(57) ABSTRACT

A communication device receives data transmissions from a data transmitter. The communication device monitors at least one quality indicator indicative of a quality of service of the data transmissions and/or of a link quality. The monitoring is performed at an application layer of the communication device. An application executed on the application layer of the communication device generates at least one power control message as a function of the monitored at least one quality indicator and transmits the at least one power control message to the data transmitter.

### TECHNICAL FIELD

Embodiments of the invention relate to wireless local area networks. Embodiments of the invention relate in particular to a communication device and to methods for performing output power control.

### BACKGROUND ART

Wireless local area networks continue to be used for an increasing number of use cases which require wireless short range communication. Examples include the communication of display data between a handheld device and a television device, proximity based communication, local area gaming, and file and other data transfers, without being limited thereto. The communication may be made between a client device and an access point of a wireless local area network (WLAN) or may be implemented as peer-to-peer (P2P) communication which does not require an access point.

With increasing popularity and increasing number of use cases of WLANs, there is an ever increasing demand for improved output power control. Output power control is important for a variety of reasons, e.g. for preventing the battery power of mobile devices from being drained too quickly, reducing interference etc.

The IEEE 802.11h standard family defines a Transmit Power Control (TPC). The TPC is based on signalling on the lowest layer between a client device and an access point. The TPC is defined for the 5 GHz band with the specific purpose of co-existence with primary services, e.g. radar avoidance.

Conventional techniques for output power control in a WLAN typically require the monitoring of data transmissions on a low layer, e.g. on a physical layer. There are various shortcomings associated with such an approach. For illustration, the physical layer procedures have only very limited access to information which defines the operation of the device at higher layers, such as information on types of data traffic or information on applications which are being executed. This limits flexibility of the conventional output power control techniques and/or imposes limitations on aggressive output power control.

### SUMMARY

There is a continued need in the art for devices and methods which mitigate at least some of shortcomings of conventional output power control techniques in a wireless local area network (WLAN). There is in particular a need for an output power control which provides an increased degree of flexibility.

According to embodiments of the invention, a power control signalling is implemented at higher layers of the OSI layer model. Decisions on whether an adjustment of an output power is required may be taken at the application layer, based on a monitoring of data transmissions which takes place on the application layer. The power control signalling itself may be implemented at a user plane level, for example.

Implementing the power control signalling not at the lowest layer, but at a higher layer, provides increased flexibility. A power control application of a communication device may query the operating system and/or further applications to collect information which are used to decide whether a data transmitter shall be requested to adjust its output power and/or whether the output power of the communication device itself shall be adjusted. With the relevant information being accessible to the power control application, a more aggressive output power control may be performed.

The power control protocol used for the power control signalling may be encapsulated in messages according to 802.11h or may be a proprietary power control protocol.

The power control application may use information on the maximum output power level and/or the current output power level of peer devices and/or information read locally from the operating system to determine whether the data transmitter shall be requested to adjust its output power and/or whether the output power of the communication device itself shall be adjusted. The power control application may report the maximum output power level, the current output power level and/or information on data traffic in other channels to a peer device. This allows the peer device to determine which adjustments shall be made to the output power level, for example.

A method of controlling output power in a wireless local area network comprises receiving, at a wireless communication interface of a communication device, data transmissions from a data transmitter. The method comprises monitoring, by the communication device, at least one quality indicator indicative of a quality of service of the data transmissions and/or of a link quality. The monitoring is performed at an application layer of the communication device. The method comprises generating, by an application at the application layer of the communication device, at least one power control message as a function of the monitored at least one quality indicator. The method comprises transmitting the at least one power control message to the data transmitter.

The application executed by the communication device may receive application data included in the data transmissions. A data rate of the application data and/or a latency of the application data may be monitored, and the at least one power control message may be generated as a function of the monitored data rate and/or latency. The data rate and/or latency of the received application data allows the communication device to determine whether an output power adjustment shall be made by the data transmitter.

The Application Data May Include a Stream of Audio Data and/or Video Data.

The application may receive power level information indicating a current output power level and/or a maximum output power level of the data transmitter. The at least one power control message may be generated as a function of the monitored at least one quality indicator and the power level information. The at least one power control message may be generated as a function of the monitored at least one quality indicator, the current output power level of the data transmitter, and the maximum output power level of the data transmitter.

Information may be retrieved from an operating system of the communication device. The at least one power control message may be generated as a function of the monitored at least one quality indicator and the information retrieved from the operating system.

The information retrieved from the operating system may include at least one of a data traffic pattern of the data transmissions, a data traffic type of the data transmissions, and active applications which are being executed on the communication device.

The communication device may inform the data transmitter of a current output power level and/or a maximum output power level of the communication device. The method may comprise determining, at the application layer of the communication device, a current output power level and/or a maximum output power level of the communication device. At least one further power control message may be generated and transmitted which includes information on the current output power level and/or the maximum output power level of the communication device.

The at least one power control message may be an asynchronous message.

The at least one power control message may be generated to adapt the power control to the application service usage.

The at least one power control message may be an Internet Protocol, IP, message.

Both the communication device and the data transmitter may be client devices of the wireless local area network.

Both the communication device and the data transmitter may be peers in peer-to-peer communication. The method may be used for controlling the output power in peer-to-peer communication.

One of the communication device and the data transmitter may be a client device of the wireless local area network, and the other one of the communication device and the data transmitter may be an access point of the wireless local area network. The method may then be used for output power control in an infrastructure-based WLAN.

The wireless communication interface may be a WiFi interface.

The method may comprise adjusting, by the data transmitter, an output power level of the data transmitter in response to receiving the at least one power control message.

The data transmitter may process the at least one power control message at an application layer of the data transmitter.

According to another embodiment, a communication device for a wireless local area network is provided. The communication device comprises a wireless communication interface configured to receive data transmissions from a data transmitter. The communication device comprises a processor executing an application which is configured to monitor, at an application layer of the communication device, at least one quality indicator indicative of a quality of service of the data transmissions and/or of a link quality. The application is configured to generate at least one power control message as a function of the monitored at least one quality indicator. The application is configured to transmit the at least one power control message to the data transmitter.

The communication device may be configured to perform the method according to any embodiment. The required processing of information may be implemented at the application layer and may be performed by the processor of the communication device.

Additional features of the communication device correspond to the additional features of methods according to embodiments.

According to another embodiment, a wireless local area network is provided. The wireless local area network comprises the communication device according to an embodiment and a data transmitter configured to adjust an output power of the data transmitter in response to receiving the at least one power control message.

Devices and methods according to embodiments allow power control in a wireless local area network to be performed by using higher layer signalling. With additional information on the operation of the communication device being available to an application which performs the power control at the application layer, the power control can be adapted to the requirements of the applications which are being executed on the communication device, for example.

### BRIEF DESCRIPTION OF DRAWINGS

Embodiments of the invention will be described with reference to the accompanying drawings in which the same or similar reference numerals designate the same or similar elements.

FIG. 1 is a schematic view of a wireless local area network according to an embodiment.

FIG. 2 shows devices of a wireless local area network which perform power control signalling according to an embodiment.

FIG. 3 is a functional block diagram of a communication device according to an embodiment.

FIG. 4 illustrates the monitoring of a quality indicator and the generation of a power control message at the application layer in a communication device according to an embodiment.

FIG. 5 illustrates the monitoring of a quality indicator and the generation of a power control message at the application layer in a communication device according to an embodiment.

FIG. 6 is a flow chart of a method according to an embodiment.

### DESCRIPTION OF EMBODIMENTS

Exemplary embodiments of the invention will be described with reference to the drawings. While some embodiments will be described in the context of specific fields of application, e.g. in the context of exemplary radio access technologies, the embodiments are not limited to this field of application. The features of the various embodiments may be combined with each other unless specifically stated otherwise.

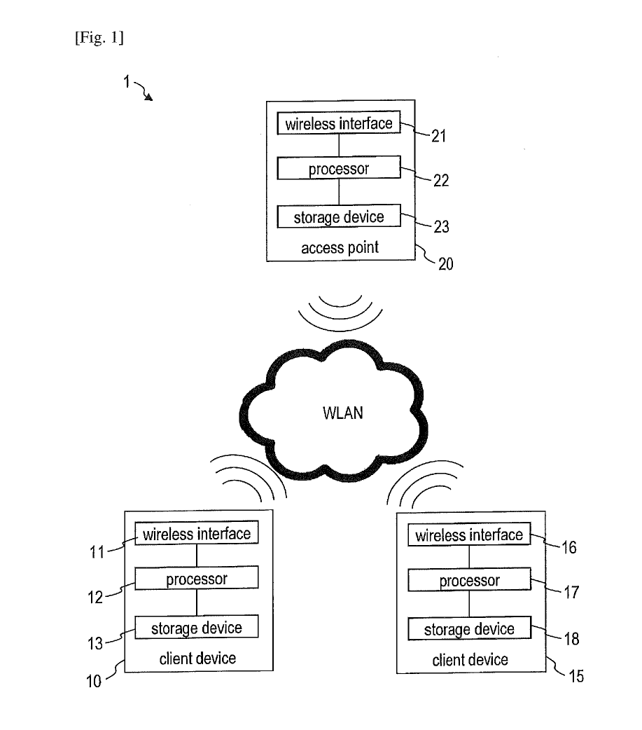

FIG. 1 is a schematic view of a wireless local area network (WLAN) 1 according to an embodiment. The WLAN 1 comprises one or several client devices 10, 15. The WLAN 1 may comprise an access point 20. As will be described in more detail in the following, the client devices 10, 15 and/or the access point 20 may be configured to perform a power control signalling at a higher layer of the OSI layer model. Decisions on power control signalling may be made at the application layer. The transmission of power control messages may be performed at a user plane level. Not only the generation of messages for output power control, but also the monitoring upon which a decision to adjust an output power is based may be performed at an application layer according to the OSI layer model.

While an infrastructure-based WLAN 1 having an access point 20 is shown in FIG. 1 for illustration, the higher layer power control signalling may also be used in peer-to-peer communication where no access point 20 is required.

A first client device 10 has a wireless communication interface 11. The wireless communication interface 11 may be a WiFi interface. The wireless communication interface 11 may be configured for communication in accordance with at least one standard of the IEEE 802.11 standard family. The wireless communication interface 11 may be an interface which is configured to communicate with a cellular network and which can perform P2P communication in a WLAN, for example.

The first client device 10 has a processor 12. The processor 12 may be configured to execute a power control application. The power control application may be operative to determine, at the application layer, whether an adjustment of the output power of a second client device 15 and/or of an access point 20 which transmits data to the first client device 10 is to be adjusted. The power control application may be configured to determine a data rate and/or latency or another indicator for a quality of service of data transmissions received by the first client device 10. The power control application may use this information to determine whether an output power of the second client device 15 and/or the access point 20 which transmits data to the first client device 10 is to be adjusted. The power control application may be operative to determine, at the application layer, whether the output power of the first client device 10 is to be adjusted. An operating system (OS) of the first client device 10 may be executed by the processor 12. The power control application may be configured to retrieve information from the operating system to determine whether an output power of the second client device 15 and/or the access point 20 which transmits data to the first client device 10 shall be adjusted. The power control application may be configured to retrieve information from the operating system to determine whether an output power of the first client device 10 is to be adjusted.

The first client device 10 may have a storage device 13. The storage device 13 may store a program code of the power control application and/or of the operating system in a non-transient manner. The storage device 13 may store information received from the second client device 15 and/or the access point 20 which is accessed by the power control application for power control.

The second client device 15 may have a wireless interface 16, a processor 17, and a storage device 18, which may have the same configuration as described for the wireless interface 11, the processor 12, and the storage device 13 of the first client device 11. In particular, the processor 17 of the second client device may execute a second power control application. The second power control application executed on the second client device 15 may perform power control signalling with the power control application executed on the first client device 10. The second power control application executed on the second client device 15 may have an identical configuration and operation as the power control application executed on the first client device 10.

The access point 20 has a wireless communication interface 21. The wireless communication interface 21 may be a WiFi interface. The wireless communication interface 21 may be configured for communication in accordance with at least one standard of the IEEE 802.11 standard family. The access point 20 has a processor 22. The processor 22 may control the access point 20 to provide access point functionality of a WLAN access point. The processor 22 may execute a power control application which may communicate with the power control application of the first client device 10 and/or the power control application of the second client device 15, in order to perform power control signalling. The access point 20 may have a storage device 23 in which data included in a power control message received from the first client device 10 and/or in a power control message received from the second client device 15 may be stored. The power control application executed on the access point 20 may perform a power control signalling with the power control application executed on the first client device 10 and/or with the second power control application executed on the second client device 15.

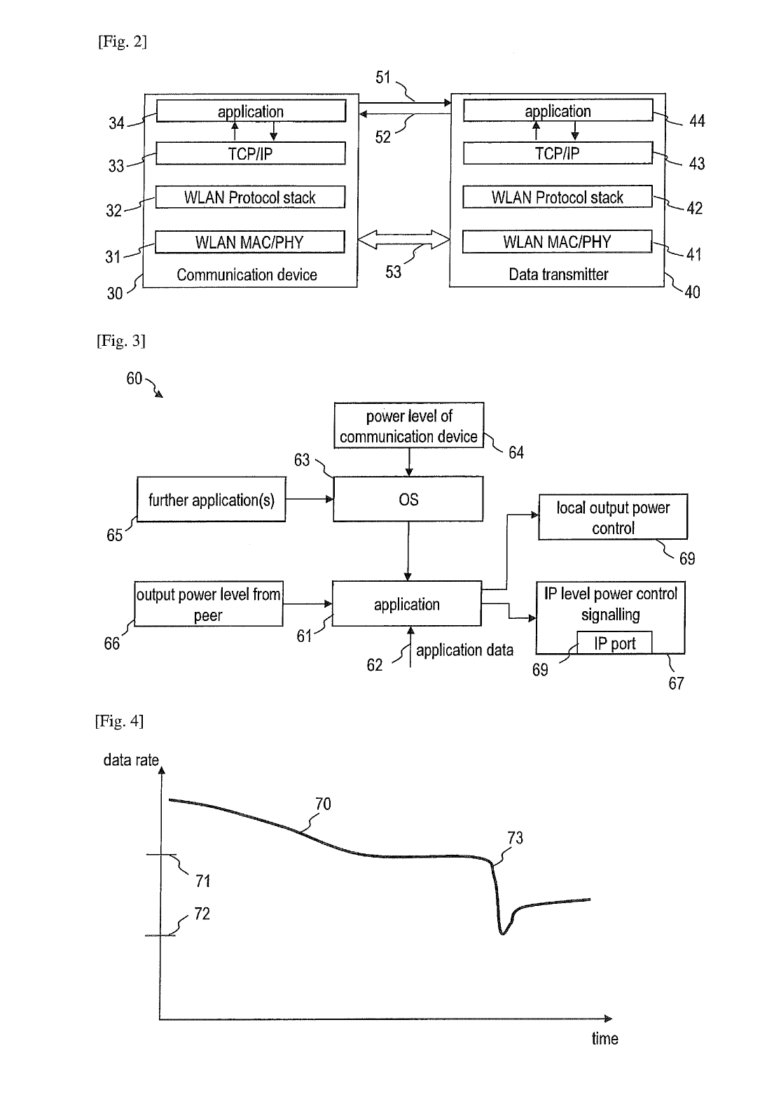

As will be explained in more detail with reference to FIG. 2 to FIG. 6 in the following, client device(s) and/or access point(s) of WLANs according to exemplary embodiments may perform an application layer power control. A communication device, which may be a client device, a peer in P2P communication, or an access point, may receive data transmission from a data transmitter. The data transmitter may be an access point, another peer in P2P communication, or a client device. The communication device may monitor application data received via the wireless interface from the data transmitter to determine whether the output power of the data transmitter and/or of the communication device is to be adjusted. The monitoring is performed at the application layer. A power control message may be generated by the communication device at a layer higher than the physical layer and may be transmitted to the data transmitter. The communication device may also adjust its own output power based on information received from the data transmitter and monitoring performed locally at the communication device.

While the term “data transmitter” will be used in the following to refer to the device from which the communication device receives data transmissions, it is to be understood that the data transmitter also includes receiving functions. For illustration, the communication device and the data transmitter may have identical configurations and may operate as peers in P2P communication.

FIG. 2 illustrates a communication device 30 and a data transmitter 40 which perform power control signalling at a layer higher than the physical layer in accordance with embodiments of the invention. The communication device 30 may be a client device, a peer in P2P communication, or an access point. The data transmitter 40 may be an access point, another peer in P2P communication, or a client device.

As schematically illustrated in FIG. 2, various layers may be implemented in the communication device 30 and the data transmitter 40. The layers may include a WLAN MAC (Media Access Control) and PHY (physical) layers 31, 41. The layers may include a TCP/IP (Transmission Control Protocol/Internet Protocol) layer 33, 43. The communication device 30 may have a WLAN protocol stack 32, and the data transmitter 40 may have a WLAN protocol stack 42.

The communication device 30 executes an application 34 which acts as power control application and performs power control signalling at a layer of the OSI layer mode which is higher than the physical layer. The power control signalling may be performed on a user plane level, for example. The power control signalling may be based on IP messages. The power control signalling may be performed on a user plane level, without requiring support in lower layers (e.g. the PHY layer).

The application 34 may monitor a quality of service (QoS) of data transmissions received from the data transmitter 40 or may monitor any other quality indicator which is indicative of the quality of service and/or link quality. Examples for such quality indicators include data rates or latencies, without being limited thereto.

The data transmitter 40 executes an application 44 which acts as power control application. The application 44 performs power control signalling at a layer of the OSI layer mode which is higher than the physical layer. The application 44 executed on the data transmitter 40 and the application 34 executed on the data transmitter 40 may be identical applications. The application 44 may provide information on a current output power level and/or a maximum output power level of the data transmitter 40 to the application 34 executed on the communication device 30. The application 44 may perform power control signalling on a user plane level, for example, to transmit information on the current output power level and/or a maximum output power level of the data transmitter 40. The power control signalling may include IP messages transmitted from the application 44 executed on the data transmitter 40 to the application 34 executed on the communication device 30.

The communication device 30 may request the data transmitter 40 to adjust the output power of the data transmitter 40. In order to determine whether the output power of the data transmitter 40 is to be adjusted, the application 34 may monitor a quality indicator for a QoS or link quality at the application layer of the communication device 30. The quality indicator may be a data rate or latency of a stream of application data received by the application 34, with the application data being included in data transmissions 53 received from the data transmitter 40. Based on the quality indicator and, optionally, additional information, the application 34 may determine whether a power control message 51 for adjusting the output power of the data transmitter 40 is to be transmitted to the data transmitter 40. The power control message 51 is generated by the application 34 executed on the application layer of the communication device 30. The power control message 51 may be transmitted on a user plane level, for example.

The communication device 30 may transmit the power control message 51 to the data transmitter 40. The power control message 51 may include information on whether and, optionally, how the output power of the data transmitter 40 is to be adjusted. The power control message 51 may include information on a current and/or maximum output power level of the communication device 30, on power measurements for several channels performed by the communication device 30, on applications that are being executed on the communication device 30, and/or on user behaviour of the communication device 30. The data transmitter 40 may use this information to determine whether and how its output power is to be adjusted.

The data transmitter 40 may transmit another power control message 52 to the communication device. The other power control message 52 may include information on a current and/or maximum output power level of the data transmitter 40, on power measurements for several channels performed by the data transmitter 40, on applications that are being executed on the data transmitter 40, and/or on user behaviour of the data transmitter 40. The other power control message 52 is generated by the application 44 executed on the application layer of the data transmitter 40. The other power control message 52 may be transmitted on a user plane level, for example. The other power control message 52 may be an IP message.

The application 34 of the communication device 30 may use the information included in the other power control message 52 when making a decision on requesting the output power level of the data transmitter 40 to be adjusted. Additionally or alternatively, the application 34 of the communication device 30 may use the information included in the other power control message 52 to determine whether and how its own output power is to be adjusted.

The application 34 may receive and process a stream of application which is included in data transmissions received from the data transmitter 40. The quality of service detected by the application 34 may depend on whether the output power level of the data transmitter 40 and/or the link quality are sufficient for the purposes of the application 34. When the quality of service detected by the application 34 at the application layer fails to meet a quality criterion, the data transmitter 40 may be requested to increase its output power level. When the quality of service detected by the application 34 at the application layer outperforms the quality criterion by a margin, e.g. if the data rates are much higher than what would be required by the application 34 and/or the latencies are much short than what would be required by the application 34, the data transmitter 40 may be requested to decrease its output power level.

Additional information may be taken into consideration by the application 34 to determine whether and how the output power level of the data transmitter 40 and/or its own output power level are to be adjusted. The additional information may include power level information on a current and maximum output power level of the data transmitter 40. For illustration, no request for increasing the output power level may be sent to the data transmitter 40 if the current output power level of the data transmitter 40 already is the maximum output power level. Information on regional limitations imposed on the output power level may be taken into account. For illustration, if the current output power level of the data transmitter 40 is already at the maximum value allowed in the country or area where the WLAN is located, the output power level may not be increased further. The regional limitations may take into account user settings, e.g. when using dedicated operation modes for regions where the maximum output power level must meet specific criteria, e.g. in an aircraft, other vehicle, or hospital.

For further illustration, the application 34 may use energy measurements for all channels over which communication is performed to determine whether and how the output power level of the data transmitter 40 and/or the output power level of the communication device 30 is to be adjusted.

For further illustration, the application 34 may read out local information from an OS of the communication device 30 which may be indicative of a data traffic pattern (e.g. voice data, high throughput data etc.) and/or a data traffic type (display data, voice packets, etc.) of the data transmissions received from the data transmitter 40. The application 34 may read out local infomration from the OS of the communication device which is indicative of the active applications. This information may be used by the application 34 to determine whether and how the output power level of the data transmitter 40 and/or the output power level of the communication device 30 are to be adjusted.

For further illustration, the application 34 may retrieve information on a current output power level and/or maximum output power level of the communication device 30 and may provide this information to the data transmitter 40.

The power control signalling 51, 52 may be implemented in various ways. The power control signalling 51, 52 may be IP level signalling. The IP messages may be encapsulated in messages defined in IEEE 802.11h. The IP messages may be transmitted in accordance with a proprietary power control protocol which is different from IEEE 802.11h.

A dedicated IP port may be defined in the mobile communication device 30 for the power control signalling. This allows several applications executed on the communication device to act on information which relates to power control. For illustration, any one of several applications executed on the mobile communication device 30 may act on information which defines whether a power control message 51 is to be transmitted from the dedicated IP port. Another dedicated IP port may be defined in the data transmitter 40 for the power control signalling.

The power control signalling may be performed as asynchronous communication. The power control message 51 and/or the other power control message 52 may be asynchronous IP messages. This ensures a fast response. The asynchronous transmission may occur with a timing which ensures that the power control is adapted to the application service usage, rather than to fast transient channel variations.

FIG. 3 is a block diagram representation of a communication device 60 according to an embodiment.

An application 61 is executed by a processor of the communication device 60. The application 61 may act as a power control application which determines, at the application layer of the OSI layer model, whether an adjustment of the output power is required for a data transmitter which is communicatively coupled with the communication device and/or whether an adjustment of the output power is required for the communication device 60 itself.

The application 61 may perform application layer monitoring of application data 62 which are received by the communication device 60 from the data transmitter. The application data 62 may include a stream of audio or video data, such as display data. The application layer monitoring may include monitoring a data rate and/or latency or another quality indicator indicative of a quality of service of the application data 62 or a link quality of a link over which the application data 62 are transmitted.

The application 61 may use information 66 on an output power level of the data transmitter, which may be a peer device in P2P communication. The information 66 may be received in the further power control message 52 from the peer device. The application 61 may taken into account the current output power level and/or the maximum output power level of the peer device when determining whether a power control message for adjusting the output power level of the peer device is to be transmitted.

The application 61 may query an operating system 63 for additional information which may be taken into account in the output power control. The additional information may include information on the data traffic type or data traffic pattern of the application data 62 received by the application 61 and/or of data received by further application(s) executed on the communication device 60.

For further illustration, one or several further applications 65 may be executed by the communication device 60. The application 61 may query the operating system 63 to determine which further application(s) 65 are being executed. This allows the application 61 to take into account the quality requirements of the further application(s) 65 when taking a decision on output power adjustments.

For further illustration, the application 61 may query the operating system 63 to determine a current output power level or a maximum output power level of the communication device 60. This information may be communicated by the application 61 to a peer device.

Using any one, or any combination of, the pieces of information indicated above, the application 61 may initiate an IP level power control signalling 67 to request a peer device to adjust its output power level and/or to provide information on the output power level, energy measurements, and/or user behaviour to the peer device. A dedicated IP port 8 may be defined for the power control signalling. Additionally or alternatively, the application 61 may perform a local output power control 69 to adjust the output power level of the communication device 60.

FIG. 4 and FIG. 5 illustrate the operation of a communication device according to an embodiment. A data rate 70 and/or latency 75 of a stream of application data received from a data transmitter are monitored by an application at an application layer of the communication device. Power control signalling may be performed depending on the monitored data rate 70 and/or latency 75.

FIG. 4 illustrates a data rate 70 monitored by an application of the communication device as a function of time. The data rate 70 may be a data rate of audio and/or video data received by the communication device, for example. When the data rate 70 is above a first threshold 71, the data rate outperforms the quality requirements of the application by a margin. The application may transmit a power control message to the data transmitter when the data rate 70 is above the first threshold 71. The data transmitter may adjust its output power level in response to receiving the power control message.

When the data rate 70 falls below a second threshold 72, e.g. due to a sudden decrease in link quality at 73, the application may transmit a power control message to the data transmitter requesting the data transmitter to increase its output power. The data transmitter may adjust its output power level in response to receiving the power control message, causing the data rate to increase above the second threshold 72 required by the application.

FIG. 5 illustrates a latency 75 monitored by an application of the communication device as a function of time. The latency 75 may be a latency of audio and/or video data received by the communication device, for example. When the latency 75 is below a further first threshold 77, the latency outperforms the quality requirements of the application by a margin. The application may transmit a power control message to the data transmitter when the latency 75 is below the further first threshold 77. The data transmitter may adjust its output power level in response to receiving the power control message.

When the latency 75 increases to above a further second threshold 76, e.g. due to a sudden decrease in link quality at 78, the application may transmit a power control message to the data transmitter requesting the data transmitter to increase its output power. The data transmitter may adjust its output power level in response to receiving the power control message, causing the latency to fall below the further second threshold 76 required by the application.

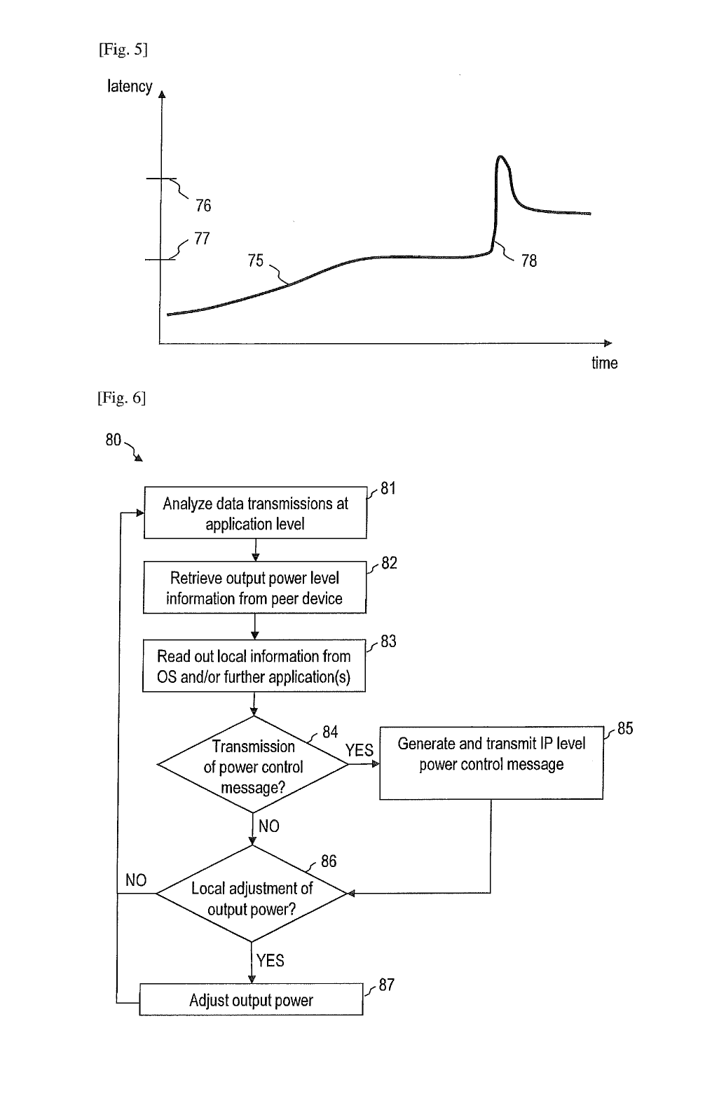

FIG. 6 is a flow chart of a method 80 according to an embodiment. The method may be performed by a communication device according to an embodiment.

At 81, an application executed by the communication device analyzes data transmissions at the application layer. This may include monitoring a quality indicator for a quality of service or a link quality, e.g. by monitoring a data rate or latency of application data received by the application.

At 82, power level information may be received from a peer device from which the data transmissions are received by the communication device. The power level information may include a maximum output power level and/or a current output power level of the peer device.

At 83, additional information may be read out from the operating system and/or further applications executed on the communication device. The additional information may include information on energy measurements performed for several channels, information on data traffic types and/or data traffic patterns of the data transmissions received from the peer device, or other information.

At 84, the information collected at steps 81-83 may be used to determine whether a power control message is to be transmitted to the peer device. If a power control message is to be transmitted, the method proceeds to step 85. At step 85, the communication device may transmit the power control message. The power control message may be generated and transmitted at a layer of the OSI layer mode which is higher than the physical layer. The power control message may be an IP layer message. The power control message may include information on the results of the analysis performed at step 81 which is transmitted to the peer device. The power control message may include a request for the peer device to increase or decrease its output power level. The power control message may include information on a current output power level and/or a maximum output power level of the communication device. After transmission of the power control message, the method may continue at step 86. If no power control message is to be transmitted, the method may proceed directly from step 84 to step 86.

At step 86, it is determined whether the output power level of the communication device itself is to be adjusted. The decision at step 86 may be based on further power control messages received from the peer device and/or any one of the pieces of information collected at steps 81-83. If the output power level of the communication device is to be adjusted, the method proceeds to step 87 to perform an adjustment of the output power level of the communication device. The method may then return to step 81. If it is determined that the output power level of the communication device does not need to be adjusted, the method may proceed directly from step 86 to step 81.

Various effects are attained by the devices and methods according to embodiments. For illustration, the higher layer power control signalling performed according to embodiments of the invention allows a power control application to base its decisions on additional information which is not available at the physical layer of the OSI layer model. Examples of such additional information include the quality requirements of the power control application, the quality requirements of further applications which execute on a communication device, the energy measured for various channels, and/or user behaviour. The implementation of the power control at the application layer provides increased flexibility. More aggressive output power control may be performed because the quality requirements of the applications executed on a communication device may be taken into account.

While exemplary embodiments have been described with reference to the drawings, modifications may be implemented in other embodiments. For illustration, the P2P communication may also be performed over a 3GPP wireless interface which is configured for P2P communication in a WLAN. For further illustration, while exemplary data have been described which may be evaluated to determine whether a communication device or a data transmitted different from the communication device is to adjust its output power, other data may be used in addition or alternatively to the data described in the context of embodiments. For illustration, user behaviour may be taken into account when taking a decision on output power adjustments.

The techniques of the embodiments described herein may be used for power control in P2P communication. Examples include power control in display mirroring. In this case, the power control signalling may be performed between a display device and a communication device having a smaller display, for example. Other examples include P2P file exchange or local area gaming. The techniques of the embodiments described herein may also be used in infrastructure-based WLANs which have an access point.

1. A method of controlling output power in a wireless local area network, the method comprising:
receiving, at a wireless communication interface of a communication device, data transmissions from a data transmitter;
monitoring, by the communication device, at least one quality indicator indicative of a quality of service of the data transmissions and/or of a link quality, the monitoring being performed at an application layer of the communication device;
generating, by an application executed on the application layer of the communication device, at least one power control message as a function of the monitored at least one quality indicator; and
transmitting the at least one power control message to the data transmitter.

2. The method of claim 1,
wherein the application executed by the communication device receives application data included in the data transmissions,
wherein the monitoring comprises: monitoring a data rate of the application data and/or a latency of the application data.

3. The method of claim 2,
wherein the application data includes a stream of audio data and/or video data.

4. The method of claim 2, further comprising:
receiving, by the application, power level information indicating a current output power level and/or a maximum output power level of the data transmitter,
wherein the at least one power control message is generated as a function of the monitored at least one quality indicator and the power level information.

5. The method of claim 1, further comprising:
retrieving information from an operating system of the communication device,
wherein the at least one power control message is generated as a function of the monitored at least one quality indicator and the information retrieved from the operating system.

6. The method of claim 5,
wherein the information retrieved from the operating system includes at least one of:
a data traffic pattern of the data transmissions,
a data traffic type of the data transmissions, or
active applications which are being executed on the communication device.

7. The method of claim 1, further comprising:
determining, at the application layer of the communication device, a current output power level and/or a maximum output power level of the communication device, and
generating and transmitting at least one further power control message which includes information on the current output power level and/or the maximum output power level of the communication device.

8. The method of claim 1,
wherein the at least one power control message is an asynchronous message.

9. The method of claim 1,
wherein the at least one power control message is an Internet Protocol (IP) message.

10. The method of claim 1, used for controlling the output power in peer-to-peer communication.

11. The method of claim 1, further comprising:
adjusting, by the data transmitter, an output power level of the data transmitter in response to receiving the at least one power control message.

12. The method of claim 11,
wherein the data transmitter processes the at least one power control message at an application layer of the data transmitter.

13. A communication device for a wireless local area network, the communication device comprising:
a wireless communication interface configured to receive data transmissions from a data transmitter, and
a processor executing an application which is configured to:
monitor, at the application layer of the communication device, at least one quality indicator indicative of a quality of service of the data transmissions and/or of a link quality;
generate at least one power control message as a function of the monitored at least one quality indicator; and
transmit the at least one power control message to the data transmitter.

14-15. (canceled)

16. The communication device of claim 13,
wherein the application executed by the communication device receives application data included in the data transmissions,
wherein the processor is configured to monitor a data rate of the application data and/or a latency of the application data to monitor the at least one quality indicator.

17. The communication device of claim 16, wherein the application data includes a stream of audio data and/or video data.

18. The communication device of claim 16,
wherein the application is configured to receive power level information indicating a current output power level and/or a maximum output power level of the data transmitter,
wherein the at least one power control message is generated as a function of the monitored at least one quality indicator and the power level information.

19. The communication device of claim 13,
wherein the processor is configured to retrieve information from an operating system of the communication device,
wherein the at least one power control message is generated as a function of the monitored at least one quality indicator and the information retrieved from the operating system.

20. A wireless local area network comprising:
a data transmitter; and
a communication device for a wireless local area network, the communication device comprising:
a wireless communication interface configured to receive data transmissions from the data transmitter, and
a processor executing an application which is configured to
monitor, at the application layer of the communication device, at least one quality indicator indicative of a quality of service of the data transmissions and/or of a link quality;
generate at least one power control message as a function of the monitored at least one quality indicator; and
transmit the at least one power control message to the data transmitter;
the data transmitter being configured to adjust an output power of the data transmitter in response to receiving the at least one power control message.
